(19) United States
(12) Patent Application Publication
(10) Pub. No.: US 2013/0285883 A1
(43) Pub. Date: Oct. 31, 2013

(54) HYBRID DISPLAY MONITOR

(71) Applicant: Franck DIARD, Saint-Contest (FR)

(72) Inventor: Franck DIARD, Saint-Contest (FR)

(21) Appl. No.: 13/460,740

(22) Filed: Apr. 30, 2012

(51) Int. Cl. G09G 5/00

(52) U.S. Cl. 345/2.3

(57) ABSTRACT

One embodiment is a system that includes a display monitor, a docking station, and a computing device. The display monitor includes firmware that receives display frames and causes the display frames to be displayed. The docking station is coupled to the monitor and includes a connector device and a wireless receiver. The computing device includes a processing unit that generates display frames, a software driver, and a wireless transmitter. When the computing device is connected to the connector device, the processing unit transmits display frames to the display monitor via the connector device. When the software driver detects that the computing device has disconnected from the connector device, the software driver causes the processing unit to send the display frames to the wireless transmitter, which then transmits the display frames to the display monitor via a wireless connection established between the wireless transmitter and the wireless receiver.

### BACKGROUND OF THE INVENTION

1. Field of the Invention

The present invention generally relates to display monitors for computer systems and, more particularly to a hybrid display monitor.

2. Description of the Related Art

Many computer users, when working on a computer at a desk prefer to work on systems that include higher-end display monitors. Not only are such display monitors typically larger, allowing an enhanced viewing experience and allowing more application windows to be displayed simultaneously, these monitors provide better resolution and color than lower-end display monitors. However, in many workspace settings, such as an office, a lab, or a study area, users often desire or are required to work away from their desks where their computers are usually located. In such situations, users typically need or want to bring their computers with them so they can continue working while away from their desks.

The above use-scenario presents a dilemma for users. On the one-hand, they want to use high-end display monitors that are typically associated with desktop computer systems. However, on the other hand, users want the ease of portability typically associated with hand-held computing devices and laptops. Typical solutions to this problem involve using a high-end display monitor while stationed at a desk, but then using the much smaller and inferior displays that are provided with hand-held computing devices and laptops when working away from a desk.

As the foregoing illustrates, what is need in the art is a system that allows the use of a higher-end display monitor regardless of whether a user is working where display monitor is located or away from where the display monitor is located.

### SUMMARY OF THE INVENTION

One embodiment of the invention sets forth system that includes a display monitor, a docking station, and a computing device. The display monitor includes firmware configured to receive display frames and cause those display frames to be displayed on the display monitor. The docking station is coupled to the display monitor and includes a connector device and a wireless receiver. The computing device includes a processing unit that is configured to generate a first plurality of display frames and a second plurality of display frames, a software driver, and a wireless transmitter. When the computing device is connected to the connector device, the processing unit transmits the first plurality of display frames to the display monitor via the connector device. When the software driver detects that the computing device has disconnected from the connector device, the software driver is configured to cause the processing unit to send the second plurality of display frames to the wireless transmitter, and the wireless transmitter is configured to transmit the second plurality of display frames to the display monitor via a wireless connection established between the wireless transmitter and the wireless receiver.

One advantage of the disclosed system is that a user is able to use the display monitor for displaying application windows and other frame data regardless of whether the user is working where the display monitor is located or away from where the display monitor is located.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1B are conceptual illustrations of a system configured to implement one or more aspects of the present invention;

FIG. 2 is a block diagram of the computing device of FIGS. 1A-1B, according to one embodiment of the present invention;

FIG. 3 is a block diagram of the docking station and the display monitor of FIGS. 1A-1B, according to one embodiment of the present invention; and

FIG. 4 is a flow diagram of method steps for changing display modes, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

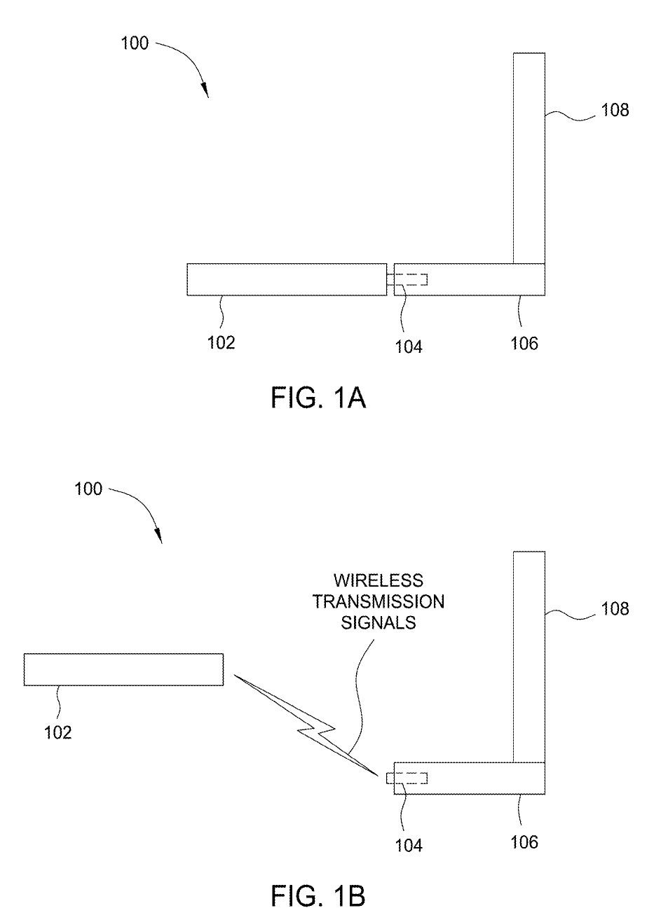

FIGS. 1A-1B are conceptual illustrations of a system 100 configured to implement one or more aspects of the present invention. As shown in FIG. 1A, the system 100 includes, without limitation, a computing device 102 coupled to a docking station 106 via a connector device 104. The docking station is coupled to a display monitor 108.

The computing device 102 may be any hand-held or portable computing device, such as a tablet computer, cellular or mobile telephone, a personal digital assistant, a laptop computer, or the like. In various embodiments, the computing device 102 may have a touch-screen interface, a more conventional key-board/mouse device interface, or any combination thereof, that enables a user to provide input for applications executing on the computing device 102, The connector device 104 may be any technically feasible connector, such as a universal serial bus connector, though which data processed by the computing device 102 may be transmitted to the display monitor 108 for display. The display monitor 108 preferably is a high-end display device, but, in various embodiments, the display monitor 108 may be any type of display device having any size, shape or display quality.

With the configuration of the system 100 illustrated in FIG. 1A, the user is able to interact with the system 100 as though system 100 were a “desktop” computer. For example, the user could sit in front of the system 100 at his/her desk and provide user input for applications executing on the computing device 102 via the user interface provided by the computing device 102. The computing device 102 would generate display frames that would be received and displayed by the display monitor 108 via the connector device 104.

In some embodiments, the docking station 106 and the display monitor 108 operate via AC (alternating current) power, thereby advantageously allowing one or more batteries included within the computing device 102 to charge while connected to the docking station 106 via the connector device 104.

As shown in FIG. 1B, the user may disconnect the computing device 102 from the docking station 106 and continue using the computing device 102 to run one or more applications. In such situations, a wireless connection is established between the computing device 102 and the docking station 106 over which the computing device 102 may continue transmitting display frames to the display monitor 108 for display. The wireless connection may be any type of technically feasible wireless connection using any technically feasible wireless protocol, such as Wi-Fi (wireless fidelity), Bluetooth, or the like. In one embodiment, the wireless connection is a peer-to-peer Wi-Fi connection, where the parameters for the connection are negotiated while the computing device 102 is connected to the docking station 106 via the connector device 104, as described above in conjunction with FIG. 1A.

With the configuration of the system 100 illustrated in FIG. 1B, the user is afforded the flexibility to “disconnect” from the docking station 106 and display 108 and “roam” around his/her workspace. For example, the user could walk around his/her lab, study area, home, office, or school and continue to provide user input to applications executing on the computing device 102 via the user interface provided by the computing device 102. The computing device 102 would generate display frames and then transmit those display frames to the docking station 106 via the wireless connection established between the computing device 102 and the docking station 106. The display frames would then be displayed by the display monitor 108.

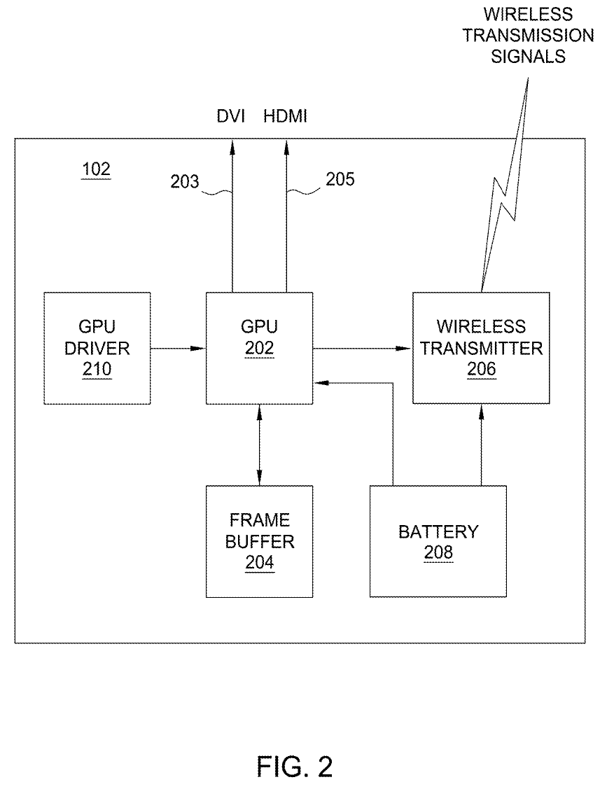

FIG. 2 is a block diagram of the computing device 102 of FIGS. 1A-1B, according to one embodiment of the present invention. As shown, the computing device 102 includes, without limitation, a graphics processing unit (GPU) 202 (or other similar processing unit), frame buffer 204, a GPU driver 210, a wireless transmitter 206, and at least one battery 208. The GPU 202 is configured to generate display frames for display based on one or more applications executing on the computing device 102 (executing within a central processing unit (not shown) or the GPU 202) and, in some cases, input received from the user via the user interface provided by the computing device 102. The frame buffer 204 is a local memory coupled to the GPU 202 and is configured to store, among other things, intermediate data and final display data (i.e., final display frames for display).

The GPU driver 210 is configured to control many aspects of the processing performed by the GPU 202 including where the GPU 202 sends completed display frames. In particular, when the GPU driver 210 detects that the computing device 102 is connected to the docking station 106 via the connector device 104, the GPU driver 210 configures the GPU 202 to transmit completed display frames to the display monitor 108 via either DVI (digital visual interface) connection 203 or HDMI (high-definition multimedia interface) connection 205. These connections are established with the docking station 106 via dedicated pins included in the connector device 104. However, when the GPU driver 210 detects that the computing device 102 has been disconnected from the docking station 106 and connector device 104, the GPU driver 210 configures the GPU 202 to send completed display frames to the wireless transmitter 206 so that the display frames can be transmitted to the display monitor 108 via the wireless connection established between the computing device 102 and the docking station 106.

In one embodiment, the GPU 202 is configured to compress the completed display frames prior to transmitting the display frames to the docking station 106 via either the DVI connection 203 or the HDMI connection 205 or prior to sending the display frames to the wireless transmitter 206 for transmission to the docking station 106. Any technically feasible compression scheme may be implemented by the GPU 202, such as the compression schemes included in the H.264 (International Telecommunications Union Standardization Sector) or MPEG (Motion Picture Experts Group) standards. In addition, as described in greater detail below, in one embodiment, prior to sending display frames to wireless transmitter 206 for transmission to the docking station 106, the GPU 202 is configured to encrypt the display frames. Any technically feasible encryption scheme may be implemented by the GPU 202, such as public key encryption or identity-based encryption.

The battery 208 is configured to provide power to the computing device 102 when the computing device 102 is disconnected from the docking station 106 but still being used by the user. As described above, in one embodiment, the docking station 106 and display monitor 108 are configured to run on AC power, which enables the computing device 102 to be run on AC power as well when connected to the docking station 106 via the connector device 104 and also enables the battery 208 to charge when the computing device 102 is connected to the docking station 106 via the connector device 104.

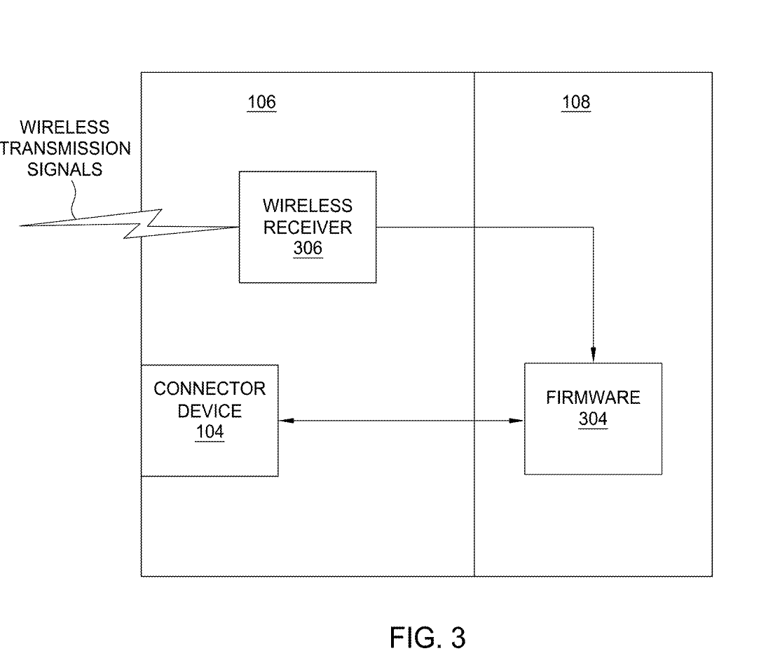

FIG. 3 is a block diagram of the docking station 106 and the display monitor 108 of FIGS. 1A-1B, according to one embodiment of the present invention. As shown, the docking station 106 includes, without limitation, a wireless receiver 306 and the connector device 104, and the display monitor 108 includes, without limitation, firmware 304. As previously described herein, the connector device 104 is configured to receive display frames generated by the GPU 202 when the computing device 102 is coupled to the docking station 106 via the connector device 104. The connector device 104 receives those display frames via either a DVI connection or an HDMI connection (or some other like connection) established using dedicated pins in the connector device 104. The connector device 104 is further configured to send the display frames received from the GPU 202 to the firmware 304 so that the display frames can be displayed on the display monitor 108.

As also previously described herein, the wireless receiver 306 is configured to establish a wireless connection with the wireless transmitter 206 included in the computing device 102 so that display frames may be transmitted from the computing device 102 to the display monitor 108 when the computing device 102 is disconnected from the docking station 106. Again, the wireless connection can be any technically feasible wireless connection, including, without limitation, a Wi-Fi connection or a Bluetooth connection. Upon receiving display frames transmitted by the wireless transmitter 206, the wireless receiver 306 is configured to send the display frames to the firmware 304 so that the display frames can be displayed on the display monitor 108.

The firmware 304 is configured to receive display frames from either the connector device 104 or the wireless receiver 306, as the case may be, and cause the display frames to be displayed on the display monitor 108. In embodiments where the GPU 202 compresses the display frames prior to transmitting the display frames to the display monitor 108 via the connector device 104 or compresses the display frames prior to sending the display frames to the wireless transmitter 206 for transmission to the display monitor 108 via the wireless receiver 306, the firmware 304 is configured to decompress the display frames before causing the display frames to be displayed on the display monitor 108. Similarly, in embodiments where the GPU 202 encrypts the display frames prior to sending the display frames to the wireless transmitter 206 for transmission to the display monitor 108 via the wireless receiver 306, the firmware 304 is configured to decrypt the display frames before causing the display frames to be displayed on the display monitor 108.

Further, as previously described herein, when the computing device 102 is connected to the docking station 106 via the connector device 104, the firmware 304 and the GPU 202 are configured to perform an encryption handshake to set up an encryption scheme through which display frames may be securely transmitted from the computing device 102 to the display monitor 108 when the computing device 102 is disconnected from the docking station 106. In addition, as also previously described herein, when the computing device 102 is connected to the docking station 106 via the connector device 104, the firmware 304 and the GPU 202 are configured to negotiate the parameters for the wireless connection that is established between the wireless transmitter 206 and the wireless receiver 306 when the computing device 102 is disconnected from the docking station 106. Such an approach advantageously allows the wireless connection to be established when the computing device 102 is disconnected from the docking station 106 with little or no user-based configuration.

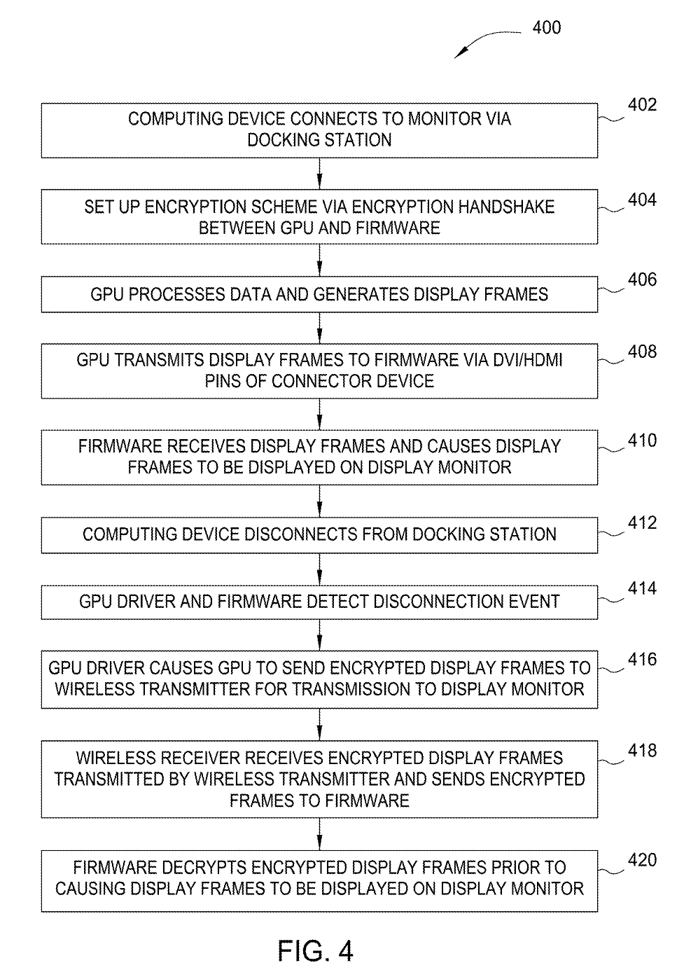

FIG. 4 is a flow diagram of method steps for changing display modes, according to one embodiment of the present invention. Although the method steps are described with respect to the systems of FIGS. 1A-3, persons skilled in the art will understand that any system configured to perform the method steps, in any order, falls within the scope of the present invention.

The method 400 starts at step 402, where a user connects a computing device 102 to a docking station 106 that is coupled to a display monitor 108. In one embodiment, the docking station 106 includes a connector device 104, such as a USB port, through which the computing device 102 connects to the docketing station 106. While docked, a battery 208 including within the computing device 102 is able to recharge, as needed, because the docking station runs on NC power. At step 404, a GPU 202 within the computing device 102 and firmware 304 within the display monitor 208 perform an encryption handshake to set up an encryption scheme through which display frames may be generated by the GPU 202 and securely transmitted to the display monitor 108 for display. The encryption scheme may include any technically feasible form of encryption, such as public key encryption or identity-based encryption.

At step 406, the GPU 202 processes application data and user input and generates display frames for display on the display monitor 108. At step 408, the GPU 202 transmits those display frames to the firmware 304 via the DVI or HDMI pins included in the connector device 104. At step 410, the firmware 304 receives the display frames and causes the display frame to be displayed on the display monitor 108. In various embodiments, the GPU 202 may compress the display frames prior to transmitting the display frame to the firmware 304. Again, any technically feasible compression scheme may be used, such as those implemented via the H.264 or MPEG standards. In such instances, the firmware 304 decompresses the display frames prior to causing the display frames to be display on the display monitor 108.

At step 412, the user disconnects the computing device 102 from the docking station, but continues to run applications on the computing device 102 and generate user input to those applications. Therefore, the GPU 202 continues to generate display frames for display on the display monitor 108. At step 414, both the GPU driver 210 within the computing device 102 and the firmware 304 detect that the computing device 102 has been disconnected from the docking station 106 (these elements detect the “disconnection event”). At step 416, the GPU driver 210 causes the GPU 202 to begin encrypting the display frames and sending the encrypted display frames to a wireless transmitter 206 included in the computing device 102 for transmission to the display monitor 108. The wireless transmitter 206 transmits the encrypted display frames to a wireless receiver 306 within the docking station 106 over a wireless connection established between the wireless transmitter 206 and the wireless receiver 306. At step 418, the wireless receiver 306 receives the encrypted display frames transmitted by the wireless transmitter 206 over the wireless connection and sends the encrypted frames to firmware 304 included within the display monitor 108. At step 420, the firmware 304 receives the encrypted display frames from the wireless receiver 306 and decrypts the display frames prior to causing the display frames to be displayed on the display monitor 108.

In various embodiments, the GPU 202 may compress the display frames prior to sending the encrypted display frame to the wireless transmitter 206 for transmission to the display monitor 108. In such instances, after receiving the display frames from the wireless receiver 306, the firmware 304 decompresses and decrypts the display frames prior to causing the display frames to be display on the display monitor 108.

One advantage of the disclosed approach is that a user is able to use the display monitor for displaying application windows and other frame data regardless of whether the user is working where the display monitor is located or away from where the display monitor is located. In addition, when working remotely from the display monitor, the approach allows the display frames to be encrypted for more secure wireless transmission. Further, both the encryption scheme and the wireless connection may be established automatically with little or no user-based configuration, thereby enhancing the overall user experience.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of the present invention is determined by the claims that follow.

The invention claimed is:

1. A method for transmitting display data to a monitor for display, the method comprising:
transmitting a first plurality of display frames to the display monitor for display via a connector device;
detecting that a computing device has disconnected from the connector device;
in response, causing a processing unit to send a second plurality of display frames to a wireless transmitter; and
transmitting the second plurality of display frames to the display monitor via a wireless connection.

2. The method of claim 1, further comprising performing an encryption handshake to set up an encryption scheme.

3. The method of claim 2, wherein display frames of the second plurality of display frames are encrypted according to the encryption scheme prior to being transmitted to the display monitor.

4. The method of claim 3, further comprising decrypting the display frames of the second plurality of display frames prior to displaying the second plurality of display frames.

5. The method of claim 1, wherein the display frames of the first plurality of display frames are compressed prior to being transmitted to the display monitor.

6. The method of claim 5, further comprising decompressing the display frames of the first plurality of display frames prior to displaying the first plurality of display frames.

7. The method of claim 1, wherein the display frames of the second plurality of display frames are compressed prior to being transmitted to the display monitor.

8. the method of claim 7, further comprising decompressing the display frames of the second plurality of display frames prior to displaying the second plurality of display frames.

9. A system, comprising:
a display monitor that includes firmware configured to receive display frames and cause the display frames to be displayed;
a docking station coupled to the monitor and including a connector device and a wireless receiver; and
a computing device that includes:
a processing unit configured to generate a first plurality of display frames and a second plurality of display frames;
a software driver; and
a wireless transmitter,
wherein, when the computing device is connected to the connector device, the processing unit transmits the first plurality of display frames to the display monitor via the connector device, and
wherein, when the software driver detects that the computing device has disconnected from the connector device, the software driver is configured to cause the processing unit to send the second plurality of display frames to the wireless transmitter, and the wireless transmitter is configured to transmit the second plurality of display frames to the display monitor via a wireless connection established between the wireless transmitter and the wireless receiver.

10. The system of claim 9, wherein the processing unit comprises a graphics processing unit.

11. The system of claim 9, wherein, when the computing device is connected to the connector device, the processing unit and the firmware perform an encryption handshake to set up an encryption scheme.

12. The system of claim 11, wherein the processing unit is configured to encrypt the display frames of the second plurality of display frames prior to sending the second plurality of display frames to the wireless transmitter.

13. The system of claim 12, wherein the wireless receiver is configured to receive the second plurality of display frames via the wireless connection and send the second plurality of display frames to the firmware.

14. The system of claim 13, wherein the firmware is configured to decrypt the display frames of the second plurality of display frames and then cause the second plurality of display frames to be displayed on the display monitor.

15. The system of claim 9, wherein the processing unit is configured to compress the display frames of the first plurality of display frames prior to transmitting the first plurality of display frames to the display monitor and to compress the display frames of the second plurality of display frames or prior to sending the second plurality of display frames to the wireless transmitter.

16. The system of claim 15, wherein the firmware is configured to decompress the display frames of the first plurality of display frames prior to causing the first plurality of display frames to be displayed on the display device and to decompress the display frames of the second plurality of display frames prior to causing the second plurality of display frames to be displayed on the display device.

17. A computing device, comprising:
a processing unit configured to generate a first plurality of display frames and a second plurality of display frames;
a software driver; and
a wireless transmitter,
wherein, when the computing device is connected to a connector device included in a docking station, the processing unit transmits the first plurality of display frames to a display monitor coupled to the docking station via the connector device, and
wherein, when the software driver detects that the computing device has disconnected from the connector device, the software driver is configured to cause the processing unit to send the second plurality of display frames to the wireless transmitter, and the wireless transmitter is configured to transmit the second plurality of display frames to the display monitor via a wireless connection established between the wireless transmitter and a wireless receiver included in the docking station.

18. The system of claim 17, wherein, when the computing device is connected to the connector device, the processing unit and firmware included in the display monitor perform an encryption handshake to set up an encryption scheme.

19. The system of claim 18, wherein the processing unit is configured to encrypt the display frames of the second plurality of display frames prior to sending the second plurality of display frames to the wireless transmitter.

20. The system of claim 17, wherein the processing unit is configured to compress the display frames of the first plurality of display frames prior to transmitting the first plurality of display frames to the display monitor and to compress the display frames of the second plurality of display frames or prior to sending the second plurality of display frames to the wireless transmitter.
